(19) United States
(12) Patent Application Publication
(10) Pub. No.: US 2010/0143093 A1
(43) Pub. Date: Jun. 10, 2010

(54) ARRANGEMENT TO DETECT A HIGH ROTATIONAL-SPEED OF A BLADE

(76) Inventors: Per Egedal, Herning (DK); Jens Christian Kjeldsen, Herning (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/633,153

(22) Filed: Dec. 8, 2009

(30) Foreign Application Priority Data
Dec. 9, 2008 (EP) 08021381.2

(51) Int. Cl. F03D 7/04; F03D 11/00; G01M 15/14

(52) U.S. Cl. 415/4.3; 415/151; 415/118; 73/112.01

(57) ABSTRACT

An arrangement for determining a rotational-speed of a blade rotating around an axis is provided. A transmit-unit is located at the rotating blade, while a receive-unit is located at the rotating hub of the blade. The transmit-unit and the receive-unit are connected by a transmission-system, which is used to transmit a signal from the transmit-unit to the receive-unit. A detection-unit is located at the blade, which is used to detect a force acting on the blade due to the rotation of the blade. The detection-unit is built to interrupt the transmission of the signal when the detected force exceeds a predetermined value. The receive-unit comprises a control-unit, which detects a high rotational-speed of the blade by evaluating the interrupted transmission of the signal. The transmission-system is built as an optical-transmission system, which transmits an optical-signal from the transmit-unit to the receive-unit for evaluation.

### CROSS REFERENCE TO RELATED APPLICATIONS

This application claims priority of European Patent Office Application No. 08021381.2 EP filed Dec. 9, 2008, which is incorporated by reference herein in its entirety.

### FIELD OF INVENTION

The invention relates to an arrangement to detect a high rotational-speed of a blade, especially of a wind-turbine-blade.

### BACKGROUND OF INVENTION

The rotational-speed of wind-turbine-blades has to be monitored continuously to prevent damages, which result from e.g. high wind-speeds acting on the blade.

If the rotational-speed exceeds a predefined value the wind-blades has to be turned out from the wind to decrease the rotational speed.

The rotational-speed of blades can be detected precisely, if a sensor is placed at the rotating blade. The sensor is prepared to detect an actual centrifugal or centripetal force, acting on the blade because of its rotation.

If the measured force is too high, a signal is transmitted by help of electrical wires to a control-unit for further processing. The control-unit may be part of the wind-turbine in a preferred embodiment.

The used electrical wires need to be protected from lightning to avoid lightning damages of the whole system.

This wire-bound system is expensive and complex because of the needed lightning-protection.

### SUMMARY OF INVENTION

It is an object of the invention to provide an improved arrangement to detect a high rotational-speed of a rotating blade.

This object is solved by an arrangement as claimed in the independent claim.

Preferred embodiments of the invention are subject of the dependent claims.

An arrangement is used to determine the rotational-speed of a blade, which rotates around an axis. A transmit-unit is located at the rotating blade, while a receive-unit is located at the rotating hub of the blade. The transmit-unit and the receive-unit are connected by a transmission-system, which is used to transmit a signal from the transmit-unit to the receive-unit. A detection-unit is located at the blade, which is used to detect a force acting on the blade because of its rotation. The detection-unit is built to interrupt the transmission of the signal, if the detected force exceeds a predetermined value. The receive-unit comprises a control-unit, which detects a high rotational-speed of the blade by evaluating the interrupted transmission of the signal.

The transmission-system is built as an optical-transmission system, which transmits an optical-signal from the transmit-unit to the receive-unit for the evaluation.

At least one optical-signal is transmitted, to be used for the detection of a high rotational-speed. So the receive-unit and the transmit-unit are isolated galvanically from each other. So there is no need to use metallic connections between them for a wire-bound signal-transmission. This results in less effort in view of a needed lightning-protection.

In a preferred embodiment an optical sensor-unit is placed at the blade, in a certain distance from the hub. Because of this the precision of the inventive arrangement is improved, as centrifugal-forces, acting on the rotating elements, are relative to a radius of the circular movement.

The inventive arrangement is constructed as a so called “fail-safe-arrangement” in many ways. Any failure, detected by the control-unit by the interrupted signal-transmission, is resulting in an error-message.

So any failure within the optical transmission-system (light-source, optical-fibres, interrupter, light-detector) is determined.

### BRIEF DESCRIPTION OF THE DRAWINGS

The invention will be shown in more detail by help of some drawings.

FIG. 1 shows the inventive method by help of a simplified block diagram,

FIG. 2 shows a first example to build an interrupter, used for the invention, and

FIG. 3 shows another example to build an interrupter, used for the invention.

### DETAILED DESCRIPTION OF INVENTION

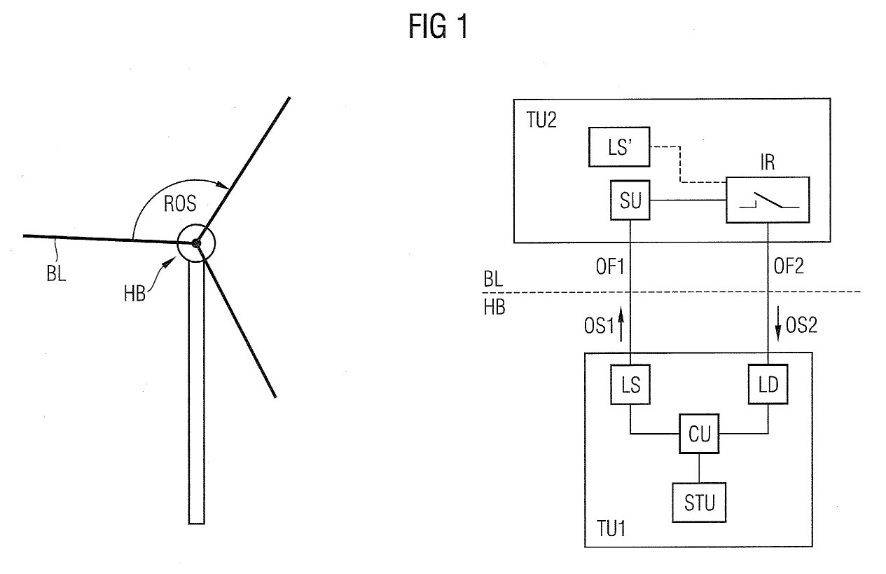

FIG. 1 shows the inventive method by help of a simplified block diagram. An exceeding rotational-speed ROS of a blade BL, which rotates around an axis, is detected by the help of a first transmit/receive-unit TU1 and by help of a second transmit/receive-unit TU2.

The first transmit/receive-unit TU1 is located at a rotating hub HB of a wind-turbine, for example. The second transmit/receive-unit TU2 is located at the rotating blade BL.

The first transmit/receive-unit TU1 and the second transmit/receive-unit TU2 are connected with two optical fibres OF1, OF2.

A first optical-fibre OF1 is used to transmit an optical first signal OS1 from the first transmit/receive-unit TU1 to the second transmit/receive-unit TU2, while a second optical-fibre OF2 is used to transmit an optical second signal OS2 from the second transmit/receive-unit TU2 to the first transmit/receive-unit TU1.

The second transmit/receive-unit TU2 may comprise a sensor-unit SU. This sensor-unit SU receives the transmitted optical signal OS1, which is generated and sent by the first transmit/receive-unit TU1 via the optical fibre OF1 to the second transmit/receive-unit TU2.

The sensor-unit SU is coupled with an interrupter IR, which is used as detection-unit. It detects a centrifugal or a centripetal force, which is acting on the blade BL because of its rotation. So this force is dependent from the rotational-speed ROS of the blade.

The interrupter IR is built to interrupt the transmission of the second signal OS2, if the detected force exceeds a predetermined value.

Because of this the sensor-unit SU only transmits the optical-signal OS1 back to the first transmit/receive-unit TU1 as optical signal OS2, if the rotational-speed ROS of the blade BL or even the related force acting on the blade BL is below a predefined value.

If the two optical fibres OF1, OF2 are optically connected with the interrupter IR, the sensor-unit SU may be omitted. In this case the interrupter IR is part of the optical transmission-path between the two fibres.

If the force exceeds the predefined value, the interrupter IR prevents the transmission of the optical-signal OS2 back to the first transmit/receive-unit TU1. So the interrupter IR may be any suitable configuration, acting as a switch.

The first transmit/receive-unit TU1 comprises a light detector LD, which is used to detect the optical-signal OS2, while this signal OS2 is transmitted from the second transmit/receive-unit TU2 to the first transmit/receive-unit TU1.

As both transmit/receive-units TU1, TU2 are rotating, they can be constantly connected to each other via the optical fibres OF1, OF2.

As described above the optical-signal OS2 will be only transmitted as long as the rotational speed ROS of the blade BL is below the predefined speed-value.

The control-unit CU is located preferably at the hub HB, within a lightning-protected zone.

So the control-unit CU will detect an interruption of the transmission of the second optical-signal OS2, which is caused by an exceeding rotational-speed ROS of the blade BL.

In this case the blade might be taken out from the wind, for example by a variation of the blade-angle, to reduce the active area of the blade attacked by the wind. So the rotational-speed ROS of the blade BL will be reduced.

The blade BL is taken out from the attacking wind by help of a steering-unit STU, which is connected with the control-unit CU.

In the example shown in FIG. 1 the first transmit/receive-unit TU1 contains a light-source LS, for example a light emitting diode or a laser diode, to generate the first optical-signal OS1.

The first transmit/receive-unit TU1 also contains a light-detector LD, for example a photodiode or a photo transistor, to detect or to receive the second optical-signal OS2.

In the example described above the first optical-signal OS1 is originated and sent by the first transmit/receive-unit TU1 and is received by the second transmit/receive-unit TU2. Then it is put through the sensor-unit SU and the interrupter IR to be used as second optical-signal OS2 for retransmission.

Because of this there are no active elements located inside the rotating blades BL.

In another embodiment the second optical-signal OS2 is generated at the side of the blade BL, so a reduction of the described optical-transmission-system is possible.

So the first optical-fibre OF1, the sensor-unit SU and also the light-source LS can be removed, while the second transmit/receive-unit TU2 will contain a light source LS′ to generate the optical-signal OS2. This optical-signal is fed into the interrupter IR for the desired retransmission.

So the functionality of the first transmit/receive-unit TU1 is reduced to a simple receiver-function, while the functionality of the second transmit/receive-unit TU2 is reduced to a simple transmitter-function.

The light-source LS, LS′ and the light-detector LD are selected in dependency of their sensitivity to other external light sources. The sensitivity should be as low as possible, to prevent that external light sources influence the functionality of the described system.

To ensure the sensitivity, the used light-source LS, LS′ generates in a preferred embodiment an optical-signal OS1, OS2 with a predefined wavelength. It is also possible to modulate the optical-signal OS1, OS2 with a certain pattern and/or with a certain frequency.

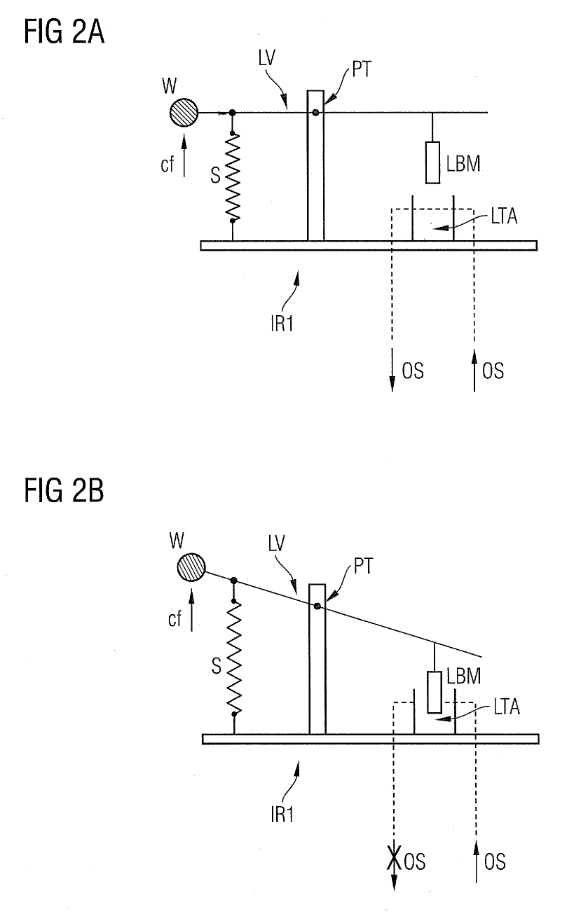

FIG. 2A and FIG. 2B show a first example to build an interrupter IR1, used for the invention. FIG. 2A show the interrupter IR1 in an inactive state.

A lever LV is mounted rotatable around a point PT. A first side of the lever LV is balanced by help of a spring S and carries also a weight W. A light-blocking-material LBM is located at a second side of the lever LV.

An optical-signal OS is allowed to pass through a light-transmission-area LTA of the interrupter IR1, as long as the rotational-speed of the blade or a related force cf is below a predefined value.

The centrifugal or centripetal force CF is related to the rotational-speed of the blade. This force cf is acting on the weight W of the lever LV, while the lever LV is balanced by help of the weight W and the spring S.

Because of this the light-blocking-material LBM is kept clear from the light-transmission-area LTA, as long as the force is below the predefined value.

FIG. 2B shows the interrupter IR1 in an active state.

If the rotational-speed of the blade exceeds the predefined wind-speed, the force CF will grow. As it is acting at the weight W, the lever LV is forced to rotate around the point PT.

Because of this rotation the light-blocking-material LBM is moved into the light-transmission-area LTA, so the optical-signal OS is blocked to be transmitted.

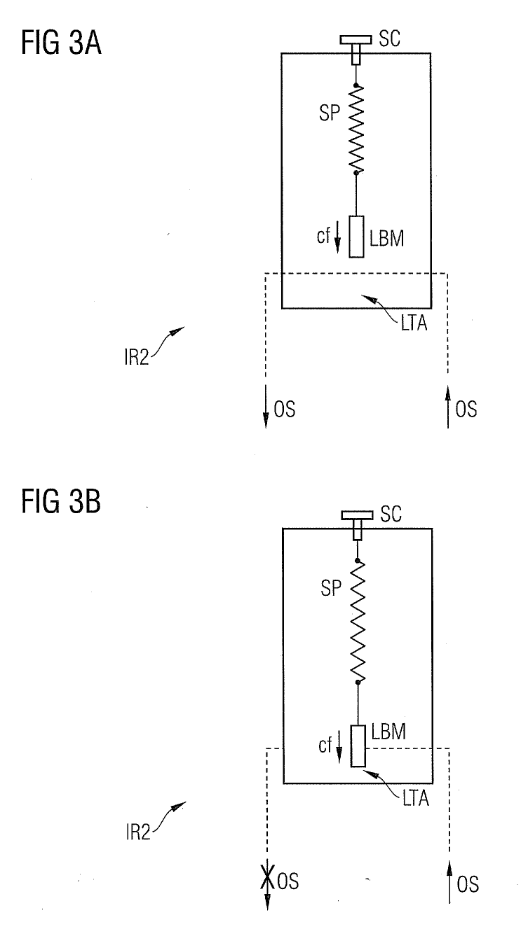

FIG. 3 shows another example to build an interrupter IR2, used for the invention.

FIG. 3A shows the interrupter IR2 in an inactive state.

A spring SP is connected with its first side with a screw SC, while the screw SC is used for calibration purposes.

A second side of the spring SP is connected with a light-blocking-material LBM, which can be moved inside a light-transmission-area LTA.

An optical-signal OS is allowed to pass through the light-transmission-area LTA of the interrupter IR2, as long as the rotational-speed of the blade and therefore the force cf is below the predefined value.

The force CF is acting on the light-blocking-material LBM, while the light-blocking-material LBM is kept clear from the light-transmission-area LTA by help of the calibrated spring SP.

FIG. 3B shows the interrupter IR2 in an active state.

If the rotational speed of the blade increases, the centrifugal force CF will grow. As it is acting on the light-blocking-material LBM, the light-blocking-material LBM is moved into the light-transmission-area LTA, if the force cf exceeds the predefined value. So the optical-signal OS is blocked to be transmitted.

FIG. 2 and FIG. 3 show basic solutions for the interrupter, realised as “mass-spring”-system, which moves a kind of piston to interrupt the optical signal-transmission.

It is also within the scope of the invention to use any kind of controlled switch or interrupter, while its control is done in dependency of the rotational speed of the rotating blade.

1.-12. (canceled)

13. Arrangement to determine a rotational-speed of a blade rotating around an axis, comprising:
a transmit-unit located at the blade;
a receive-unit located at a rotating hub of the blade;
a transmission-system for transmitting a signal from the transmit-unit to the receive-unit, the transmit-unit and the receive-unit being connected by the transmission-system;
a detection-unit located at the blade for detecting a force acting on the blade due to the rotation of the blade,
wherein the detection-unit interrupts the transmission of the signal when the detected force exceeds a predetermined value,
wherein the receive-unit comprises a control-unit detecting a high rotational-speed of the blade by evaluating an interrupted transmission of the signal, and
wherein the transmission-system is an optical-transmission system transmitting an optical-signal from the transmit-unit to the receive-unit for evaluation.

14. The arrangement as claimed in claim 13, wherein the transmit-unit and the receive-unit are connected by at least one optical fibre to transmit the optical-signal.

15. The arrangement as claimed in claim 13, wherein the transmit-unit comprises an interrupter detecting the force acting on the blade due to the rotation of the blade.

16. The arrangement as claimed in claim 15, wherein the interrupter is configured to interrupt the transmission of the optical-signal.

17. The arrangement as claimed in claim 15, wherein the control-unit is connected to a steering-unit, the steering-unit turning the blade out of an attacking wind when the transmission of the optical-signal is interrupted.

18. The arrangement as claimed in claim 16, wherein the control-unit is connected to a steering-unit, the steering-unit turning the blade out of an attacking wind when the transmission of the optical-signal is interrupted.

19. The arrangement as claimed in claim 13,
wherein the receive-unit is part of a first transmit/receive-unit comprising a light-source for generating a first optical-signal,
wherein the transmit-unit is part of a second transmit/receive-unit comprising an optical-sensor for receiving the first optical-signal, and
wherein the light-source and the optical-sensor are connected by a first optical fiber to transmit the first optical-signal from the first transmit/receive-unit to the second transmit/receive-unit.

20. The arrangement as claimed in claim 19,
wherein the second transmit/receive-unit comprises the interrupter,
wherein the first transmit/receive-unit comprises a light-detector,
wherein the interrupter and the light-detector are connected by a second optical fiber,
wherein the interrupter is inserted between the sensor-unit and the second optical fiber, and
wherein the first optical-signal is generated and sent from the light-source of the first transmit/receive-unit to the sensor-unit of the second transmit/receive-unit, the first optical-signal is received by the optical sensor and is passed through the interrupter when the detected force is below the predefined value and wherein the first optical-signal is sent back as a second optical-signal from the interrupter to the light-detector.

21. The arrangement as claimed in claim 13,
wherein the transmit-unit comprises a light-source for generating the optical-signal and an interrupter as part of the detection-unit,
wherein the receive-unit comprises a light-detector,
wherein the interrupter and the light-detector are connected by an optical fiber,
wherein the interrupter is inserted between the light-source and the optical fiber, and
wherein the optical-signal is generated and sent from the light-source to the interrupter and is passed through the interrupter only when the detected force is below the predefined value, the optical-signal being sent in this case from the interrupter to the light-detector.

22. The arrangement as claimed in claim 19, wherein the light-source is a light emitting diode or a laser diode.

23. The arrangement as claimed in claim 21, wherein the light-source is a light emitting diode or a laser diode.

24. The arrangement as claimed in claim 20, wherein the light-detector is a photodiode or a photo transistor.

25. The arrangement as claimed in claim 21, wherein the light-detector is a photodiode or a photo transistor.

26. The arrangement as claimed in claim 13, wherein the transmitted optical-signal shows a predefined wavelength and/or a predefined modulation and/or a predefined pattern and/or a predefined frequency to avoid interferences with optical-signals of the environment of the blade.

27. The arrangement as claimed in claim 19, wherein the transmitted optical-signal shows a predefined wavelength and/or a predefined modulation and/or a predefined pattern and/or a predefined frequency to avoid interferences with optical-signals of the environment of the blade.

28. The arrangement as claimed in claim 13, wherein the blade and the hub are parts of a wind-turbine.

29. The arrangement as claimed in claim 15,
wherein the interrupter comprises mechanical elements, which are moved in dependency of a centrifugal or a centripetal force, the force being related to a rotational-speed of the blade, and
wherein the mechanical elements are coupled by optical-means, which interrupt or allow a transmission of the optical signal.

30. The arrangement as claimed in claim 20,
wherein the interrupter comprises mechanical elements, which are moved in dependency of a centrifugal or a centripetal force, the force being related to a rotational-speed of the blade, and
wherein the mechanical elements are coupled by optical-means, which interrupt or allow a transmission of the optical signal.

31. The arrangement as claimed in claim 21,
wherein the interrupter comprises mechanical elements, which are moved in dependency of a centrifugal or a centripetal force, the force being related to a rotational-speed of the blade, and
wherein the mechanical elements are coupled by optical-means, which interrupt or allow a transmission of the optical signal.
